(19) United States
(12) Patent Application Publication
(10) Pub. No.: US 2010/0309225 A1
(43) Pub. Date: Dec. 9, 2010

(54) IMAGE MATCHING FOR MOBILE AUGMENTED REALITY

(76) Inventors: Douglas R. Gray, Mountain View, CA (US); Yi Wu, San Jose, CA (US); Igor V. Kozintsev, San Jose, CA (US); Horst W. Haussecker, Palo Alto, CA (US); Maha El Choubassi, San Jose, CA (US)

Correspondence Address: SCHWEGMAN, LUNDBERG & WOESSNER/Intel, PO BOX 2938, MINNEAPOLIS, MN, 55402, US

(21) Appl. No.: 12/793,511

(22) Filed: Jun. 3, 2010

Related U.S. Application Data
(60) Provisional application No. 61/183,841, filed on Jun. 3, 2009.

(51) Int. Cl. G09G 5/00; G06F 17/30; G06K 9/00

(52) U.S. Cl. 345/633; 707/749; 707/769; 382/170; 707/E17.014; 707/E17.019

(57) ABSTRACT

Embodiments of a system and method for mobile augmented reality are provided. In certain embodiments, a first image is acquired at a device. Information corresponding to at least one second image matched with the first image is obtained from a server. A displayed image on the device is augmented with the obtained information.

### RELATED APPLICATION

This application claims the benefit of priority under 35 U.S.C. 119(e) to U.S. Application Ser. No. 61/183,841, filed on Jun. 3, 2009, which is incorporated herein by reference in its entirety.

### BACKGROUND

Many of the latest mobile internet devices (MIDs) feature consumer-grade cameras, wide area network (WAN) and wireless local area network (WLAN) connectivity, location sensors (e.g., global positioning system (GPS) receivers), and various orientation and motion sensors. These features can be used to implement a mobile augmented reality system on the mobile internet device. A mobile augmented reality system comprises a system that can overlay information on a live video stream. The information can include identifying distances to objects in the live video stream, provide or link to information relating to a location of a device implementing mobile augmented reality, and other information. This information can be overlaid on a display of a live video stream from the camera on the mobile internet device. This information can also be updated as the location of the mobile internet device changes. In the past few years, various methods have been suggested to present augmented content to users through mobile internet devices. More recently, several mobile augmented reality applications for mobile internet devices have been announced.

### BRIEF DESCRIPTION OF THE DRAWINGS

FIG. 1 illustrates an example of a wireless communication system.

FIG. 2 illustrates an example of a mobile internet device for communicating in the wireless communication system of FIG. 1.

FIG. 3 illustrates an example of server for use in the wireless communication system of FIG. 1.

FIG. 4 illustrates a block diagram of an example implementation of a mobile augmented reality in the communications system of FIG. 1.

FIG. 5 illustrates an example method for matching images from a mobile internet device to images in an image database.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Many previous mobile augmented reality solutions rely solely on location and orientation sensors, and, therefore require detailed location information about points of interest to be able to correctly identify visible objects. The present inventors, however, have recognized, among other things, that image matching techniques can be used to enhance a mobile augmented reality system. For example, images obtained from a live video feed can be matched with a database of images to identify objects in the live video feed. Additionally, image matching can be used for precise placement of augmenting information on a live video feed.

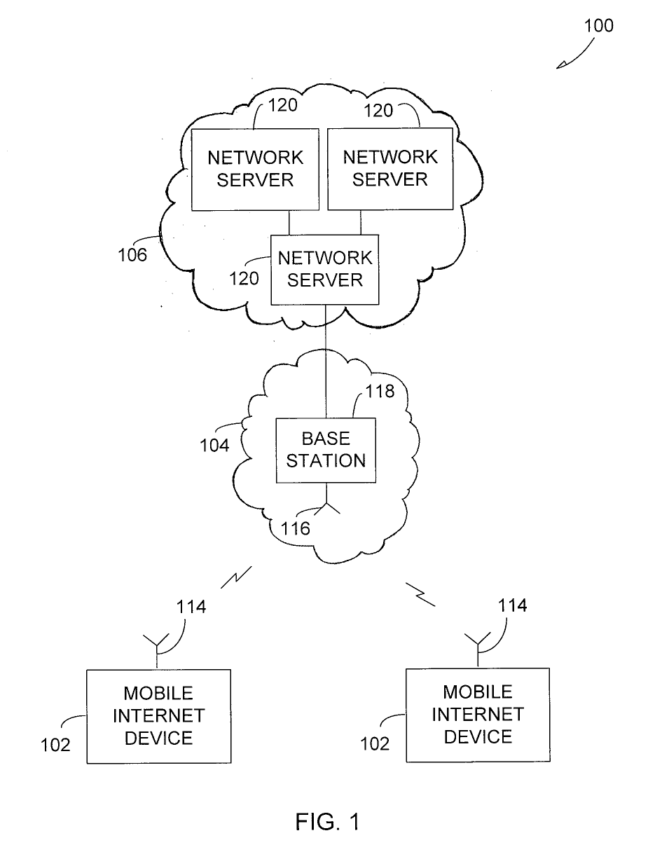

FIG. 1 illustrates an example of a wireless communication system 100. The wireless communication system 100 can include a plurality of mobile internet devices 102 in wireless communication with an access network 104. The access network 104 forwards information between the mobile internet devices 102 and the internet 106. In the internet 106 the information from the mobile internet devices 102 is sent to the appropriate destination.

In an example, each mobile internet device 102 can include one or more antennas 114 for transmitting and receiving wireless signals to/from one or more antennas 116 in the access network 104. The one or more antennas 116 can be coupled to one or more base stations 118 which are responsible for the air interface to the mobile internet devices 102. The one or more base stations 118 are communicatively coupled to network servers 120 in the internet 106.

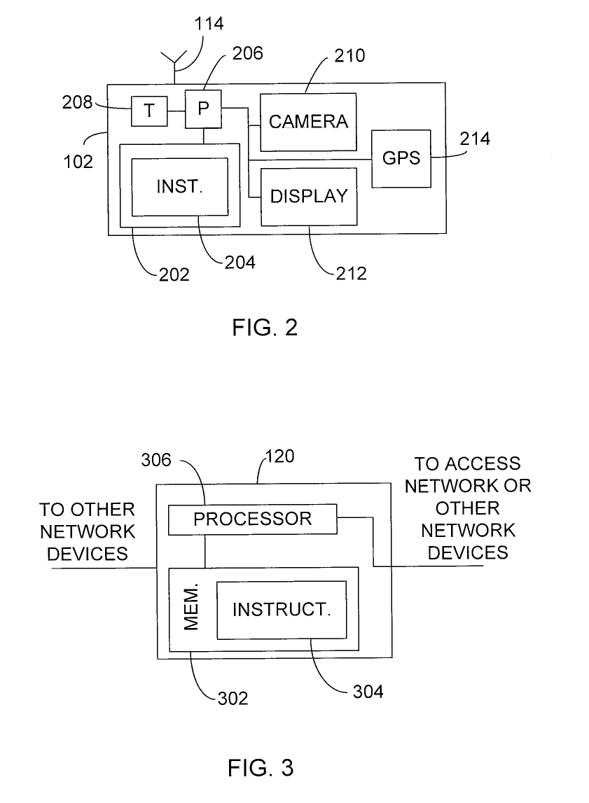

FIG. 2 illustrates an example of a mobile internet device 102. The mobile internet device 102 can include a memory 202 for storage of instructions 204 for execution on processing circuitry 206. The instructions 204 can comprise software configured to cause the mobile internet device 102 to perform actions for wireless communication between the mobile internet devices 102 and the base station 118. The mobile internet device 102 can also include an RF transceiver 208 for transmission and reception of signals coupled to an antenna 114 for radiation and sensing of signals. The mobile internet device 102 can also include a camera 210 for acquiring images of the real world. In an example, the camera 210 can have the ability to acquire both still images and moving images (video). The images acquired by the camera 210 can be stored in the memory 202 and/or can be displayed on a display 212. The display 212 can be integral with the mobile internet device 102, or can be a standalone device communicatively coupled with the mobile internet device 102. In an example, the display 212 is a liquid crystal display (LCD). The display 212 can be configured to show live video of what is currently being acquired by the camera 210 for a user to view.

The mobile internet device 102 can also include a geographical coordinate receiver 214. The geographical coordinate receiver 214 can acquire geographical coordinates (e.g., latitude and longitude) for the present location of the mobile internet device 102. In an example, the geographical coordinate receiver 214 is a global positioning system (GPS) receiver. In some examples, the mobile internet device 102 can also include other sensors such as one or more accelerometer to acquire acceleration force readings for the mobile internet device 102, one or more gyroscopes to acquire rotational force readings for the mobile internet device 102, or other sensors. In an example, one or more gyroscopes and one or more accelerometers can be used to track and acquire navigation coordinates based on motion and direction from a known geographical coordinate. The mobile internet device 102 can also include a range finder (e.g., a laser rangefinder) for acquiring data regarding the distance of an object from the mobile internet device 102.

In an example, the mobile internet device 102 can be configured to operate in accordance with one or more frequency bands and/or standards profiles including a Worldwide Interoperability for Microwave Access (WiMAX) standards profile, a WCDMA standards profile, a 3G HSPA standards profile, and a Long Term Evolution (LTE) standards profile. In some examples, the mobile internet device 102 can be configured to communicate in accordance with specific communication standards, such as the Institute of Electrical and Electronics Engineers (IEEE) standards. In particular, the mobile internet device 102 can be configured to operate in accordance with one or more versions of the IEEE 802.16 communication standard (also referred to herein as the “802.16 standard”) for wireless metropolitan area networks (WMANs) including variations and evolutions thereof. For example, the mobile internet device 102 can be configured to communicate using the IEEE 802.16-2004, the IEEE 802.16(e), and/or the 802.16(m) versions of the 802.16 standard. In some examples, the mobile internet device 102 can be configured to communicate in accordance with one or more versions of the Universal Terrestrial Radio Access Network (UTRAN) Long Term Evolution (LTE) communication standards, including LTE release 8, LTE release 9, and future releases. For more information with respect to the IEEE 802.16 standards, please refer to “IEEE Standards for Information Technology—Telecommunications and Information Exchange between Systems”—Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, release 8, March 2008, including variations and later versions (releases) thereof.

In some examples, RF transceiver 208 can be configured to transmit and receive orthogonal frequency division multiplexed (OFDM) communication signals which comprise a plurality of orthogonal subcarriers. In some of these multicarrier examples, the mobile internet device 102 can be a broadband wireless access (BWA) network communication station, such as a Worldwide Interoperability for Microwave Access (WiMAX) communication station. In other broadband multicarrier examples, the mobile internet device 102 can be a 3rd Generation Partnership Project (3GPP) Universal Terrestrial Radio Access Network (UTRAN) Long-Term-Evolution (LTE) communication station. In these broadband multicarrier examples, the mobile internet device 102 can be configured to communicate in accordance with an orthogonal frequency division multiple access (OFDMA) technique.

In other examples, the mobile internet device 102 can be configured to communicate using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation.

In some examples, the mobile internet device 102 can be a personal digital assistant (PDA), a laptop or desktop computer with wireless communication capability, a web tablet, a net-book, a wireless telephone, a wireless headset, a pager, an instant messaging device, a digital camera, an access point, a television, a medical device (e.g., a heart rate monitor, a blood pressure monitor, etc.), or other device that can receive and/or transmit information wirelessly.

FIG. 3 illustrates an example of a network server 120. The network server 120 can include a memory 302 for storage of instructions 304 for execution on processing circuitry 306. The instructions 304 can comprise software configured to cause the network server 120 to perform functions as described below.

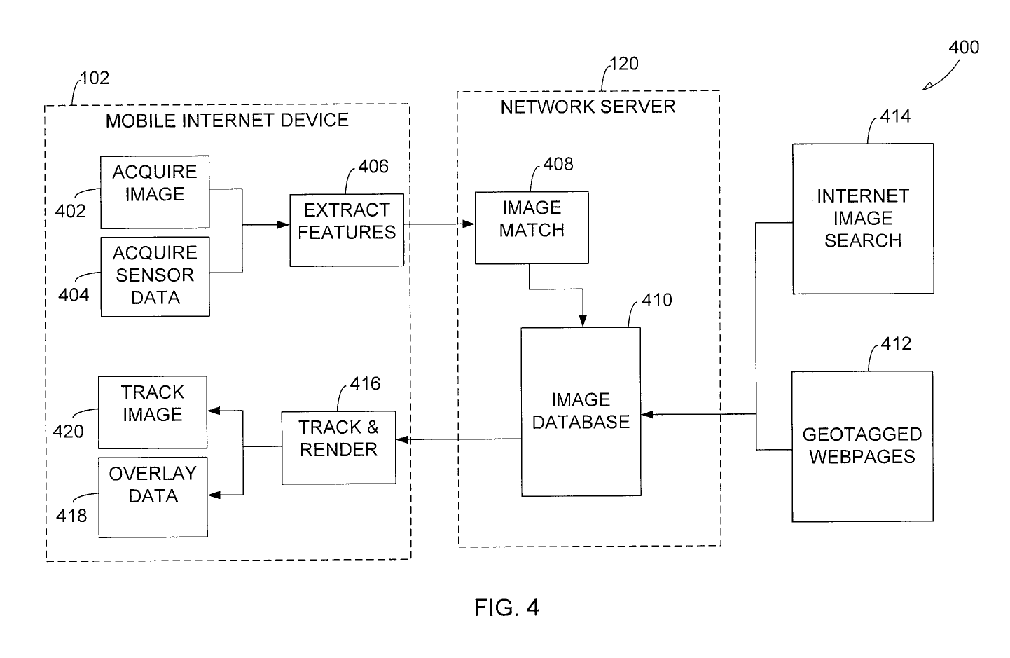

FIG. 4 illustrates a block diagram 400 of an example implementation of a mobile augmented reality in the communications system 100 of FIG. 1. At 402, the mobile internet device 102 acquires an image with the camera 210. In an example, the image is extracted from a video that the camera 210 is acquiring. For example, the camera 210 can be acquiring a video that is being displayed live on the display 212. An image can be extracted from the video for use in image matching as described below. In an example, the image can be extracted from the video when a user of the mobile internet device 102 provides a command (e.g., a button push) instructing the camera 210 to acquire an image. In another example, the camera 210 can be configured to periodically (e.g., once a second) acquire an image when the mobile internet device 102 is in a certain mode of operation. In other examples, the image can be a non live image, such as an image stored in the memory 202 or an image received from another device.

At 404, the mobile internet device 102 acquires sensor data corresponding to the image with one or more sensors. In an example, the sensor data includes navigation coordinates acquired with the GPS 214. The mobile internet device 102 can acquire the navigation coordinates at approximately the same time as the camera 210 acquires the live image. Accordingly, the geographical coordinates can correspond to the location of the mobile internet device 102 at the time that the live image is acquired by the camera 210. In other examples, the geographical coordinates can be acquired with other sensors (e.g., one or more accelerometers and one or more gyroscopes) or the geographical coordinates can be stored with a non live image in the memory 202 or received with a non live image from another device. In yet other examples, an orientation (e.g., bearing) of the mobile internet device 102 can be acquired in addition to the geographical coordinates. The orientation can be acquired based on a movement history stored by the GPS 214 or the orientation can be acquired with a gyroscope or compass. The orientation can, for example, provide information indication the direction (e.g., North) in which the camera 210 is facing relative to the location (e.g., the acquired geographical coordinates) of the mobile internet device 102. Accordingly, the acquired sensor data can include the geographical coordinates of the mobile internet device 102 at the time the image was acquired and the direction that the camera 210 is facing at the time the image was acquired. The direction information can be used to aid in identifying, more precisely, the location (e.g., navigation coordinates) of an object in the image as opposed to relying on the geographical coordinates of the mobile internet device 102 alone. Furthermore, in some examples, the mobile Internet device 102 can also include a range finder than can include a distance from the mobile internet device 102 to an object in the image.

At 406, features are extracted from the image and the features are sent to the network server 120 for matching with other images. The features can be extracted using any suitable feature extraction algorithm including, for example, 64-dimensional speeded up robust features (SURF) or scale invariant feature transform (SIFT). The extracted features and the acquired sensor data are then sent to the network processor 120. In an example, the features and sensor data are sent to the network processor 120 via the base station 118 and are routed through the internet 106 to the network processor 120. In other examples, the acquired image itself can be sent to the network server 120 along with the sensor data, and the features can be extracted by the network server 120.

In an example, the SURF feature extraction is based on OPENCV implementation. Further, hot spots in the feature extraction code can be identified and optimized. For example, the hot spots can be multi-threaded including interesting point detection, keypoint description generation and image matching. Additionally, data and computation type conversion can be used to optimize. For example, double and float data types are used widely, as well as floating point computations. The keypoint descriptor from 32-bit floating point format can be quantized to 8-bit char format. The floating point computation can be converted to fixed point computations in key algorithms. By doing that, not only the data storage is reduced by 4 times, but also the performance is improved by taking advantage of the integer operations. Additionally, the image recognition accuracy was not affected in benchmark results. Finally, vectorization can be used to optimize the feature extraction. The image match codes can be vectorized using SSE intrinsic to take advantage of 4-way SIMD units.

At 408, the features and the sensor data are used to identify images that match with the image acquired by the mobile internet device 102. When the network server 120 receives the features and the sensor data from the mobile internet device 102, the network server 120 can perform image matching to identify images from an image database 410 that match with the features from the image (query image) acquired by the mobile internet device 102.

The image database 410 used by the network server 120 to match with the query image can be populated with images available on the internet 106. In an example, the image database can be populated by crawling the internet 106 and downloading images from geotagged webpages 412. A geotagged webpage 412 can include a webpage that has geographical identification (e.g., geographical coordinates) metadata in the webpage. In an example, the image database 410 is populated by crawling an online encyclopedia website (e.g., the Wikipedia website). Accordingly, images can be downloaded from geotagged Wikipedia webpages and stored in the memory 302 on the network server 120. Along with the images, the network server 120 can store the geographical information from the geotag, as well as information linking the images to the respective geotagged webpage 412 from which they originated.

In an example, the image database 410 is also populated based on a search 414 of the internet 106 using a title of a geotagged website as a search string. For example, when a geotagged Wikipedia webpage 412 is identified, the title of the Wikipedia webpage 412 can be entered into an image search engine. In an example, Google images can be used as the image search engine. In other examples, other information, such as a summarizing metadata, from the geotagged webpage 412 can be used as a search string. One or more of the images that are identified by the image search engine can be downloaded to the image database 410, associated with the geographical information for the geotagged webpage 412 having the title that was used as the search string to find the image, and associated with the stored link to the geotagged webpage 412. Accordingly, the image database 410 can be expanded to include images on the internet 106 that do not necessarily originate from geotagged webpages 412, but can be associated with geographical information based on a presumed similarity to a geotagged webpage 412. In an example, the first X number of images identified by the search 414 are downloaded into the image database, where “X” comprises a threshold number (e.g., 5). Due to lighting, angles, and image quality even two images of the same real life entity the image may or may not be a good match for one another. Accordingly, expanding the number of images in the image database 410 can increase the likelihood that one or more of the images is a good match with the query image.

Once the images are downloaded, features are extracted from the images (e.g., with SURF or SIFT) and the extracted features are stored in the image database 410 for matching with the query image. The image database 410 can be continually or periodically updated based on new images that are discovered as the network server 120 crawls the internet 106. In other example, the image database 410 can be populated based on existing image databases (e.g., the Zurich Building Image Database (ZuBuD).

To identify which images in the image database 410 match with the query image, the network server 120 can use both the features from the query image and the sensor data associated with the query image. A plurality of candidate images from the image database 410 can be selected for comparison with the features of the query image based the distance between the navigational coordinates corresponding to the query image and the geographical information associated with the image in the image database 410. For example, when the geographical information associated with an image in the image database 410 is more than a threshold distance (e.g., 10 miles) away from the navigational coordinates for the query image, the image will not be included in the plurality of candidate images that are to be compared to the query image. When the geographical information associated with an image in the image database 410 is less than the threshold distance away from the navigational coordinates for the query image, the image will be included in the plurality of candidate images. Accordingly, the plurality of candidate images can be selected from the image database 410 based on whether images in the image database 410 are within a radius of the query image. In other examples, the threshold distance can be dynamically adjusted in order to obtain a threshold number of images in the plurality of candidate images. For example, the threshold distance can start small including a small number of images, and the threshold distance can be increased gradually including additional images until a threshold number of images are included in the plurality of candidate images. When the threshold number of images is reached, the inclusion of additional images in the plurality of candidate images is halted.

Once the plurality of candidate images is selected, each image in the plurality of candidate images can be compared to the query image to identify matching images. Advantageously, using the navigational coordinates to restrict the images to be compared to the query image can reduce the computation to identify matching images from the image database 410 by reducing the number of images that are to be compared to the query image, while still preserving all or most of the relevant images.

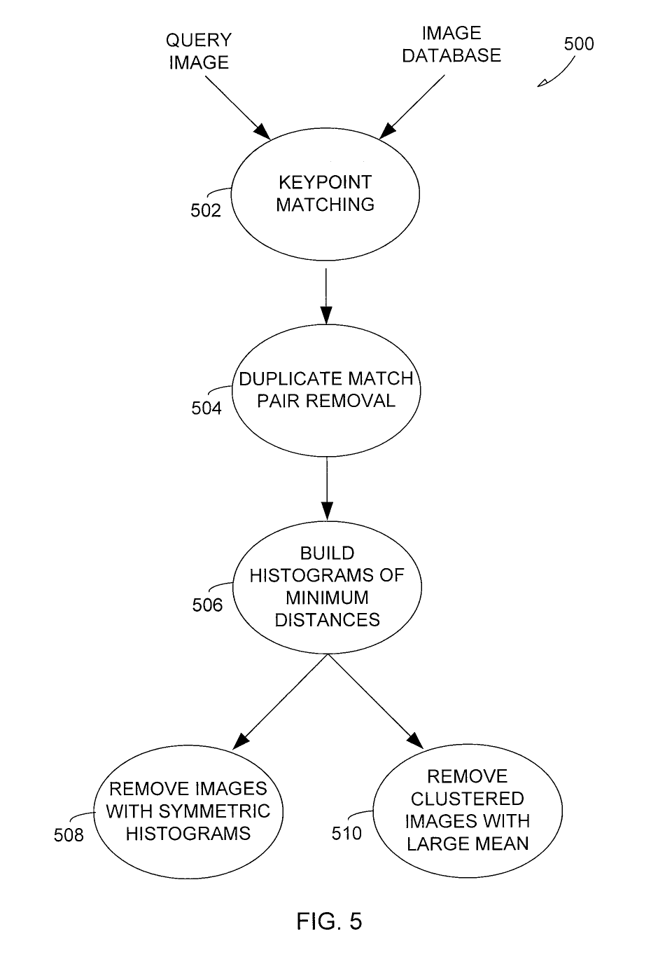

FIG. 5 illustrates an example method 500 for identifying images in a plurality of candidate images that match with the query image. At 502, keypoints (e.g., SURF keypoints) from features of the query image are compared to keypoints from features of the plurality of candidate images. When the number of images in the plurality of candidate images is smaller (e.g., <300), brute-force image matching is used, where all images in the plurality of candidate images are compared with the query image. When the number of images is large, indexing can be used as proposed by Nister & Stewinius in Scalable Recognition with a Vocabulary Tree, IEEE computer Society Conference on Computer Vision and Pattern Recognition (2006) which is hereby incorporated herein by reference in its entirety.

In an example, the query image can be compared to candidate images based on the ratio of the distance between the nearest and second nearest neighbor descriptors. For example, for a given keypoint (the query keypoint) in the query image, the minimum distance (nearest) and second minimum distance (second nearest) neighbor keypoints in a candidate image are identified based on the Ll distance between descriptors. Next, the ratio between the distances is computed to decide whether the query keypoint matches the nearest keypoint in the candidate image. When the query keypoint matches a keypoint in the candidate image, a matching pair has been identified. This is repeated for a plurality of keypoints in the query image. More detail regarding using the distance ratio to match keypoints is provided in Distinctive Image Features from Scale-Invariant Keypoints, Lowe D. G., International Journal of Computer Vision 60(2), pg. 91-110 (2004) which is hereby incorporated herein by reference in its entirety.

At 504, duplicate matches for a keypoint of a candidate image are reduced. In an example, the when a keypoint in a candidate image has multiple potential matches in the query image, the keypoint in the query image with the nearest descriptor is picked as the matching keypoint. This keypoint is not further matched with other keypoints in the query image, such that a keypoint in a candidate image can match at most one keypoint in the query image. This can improve accuracy of the ranking (described below) of the candidate images by removing duplicate matches in a candidate image with little computational cost. Accordingly, candidate images can be ranked based on the number of keypoints they posses that match different keypoints on the query image, and the results are not easily skewed by a number of keypoints in the candidate image that match a single or small number of keypoints in the query image. This can also reduce the effect of false matches. Reducing duplicate matches can be particularly advantageous when there is a large disparity between the number of keypoints in a candidate image (e.g., 155) and the number of keypoints in the query image (e.g., 2169). Without duplicate matching reduction, this imbalance can force many keypoints in the query image to match a single keypoint in a candidate image. Once the duplicate keypoints have been removed (or not originally included), the plurality of candidate images can be ranked in descending order according to the number of matching keypoint pairs. In another example, the candidate images can be ranked without removing the duplicate matches. The larger the number of matching keypoints in a candidate image the higher the ranking of the candidate image, since candidate images with higher rankings are considered closer potential matches to the query image. In an example, the closest X number of candidate images can be considered to be matching images, where X is a threshold number (e.g., ten).

At 506, the matching image results can be enhanced using by building a histogram of minimum distances. In an example, in addition to relying on the distances ratio, a histogram of minimum distances can be computed between the query image and the closest X matching images, where X is a threshold number (e.g., ten). This can be used to extract additional information about the similarity/dissimilarity between the query image and the matching images. At 508, 510, the histogram is examined to remove mismatching images. Advantageously, the computational cost of building and examining this histogram is not high since the distances are already computed.

In an example, a top ten closest matching candidate images D1, D1, . . . , D10 is obtained using the distance ratio as described at 502, 504 and/or 506. Next, each matching image pair (Q, Di) is considered at a time, and a histogram is built of minimum distances from keypoints in the query image (Q) to the candidate image (Di). For each histogram Hi, the empirical mean Mi and the skewness Si are computed according to the following equation:

$$\begin{matrix}{M}_{i} = \frac{1}{n} {\sum }_{j = 1}^{n} {H}_{i , j} , \\ {S}_{i} = \frac{\frac{1}{n} {\sum }_{j = 1}^{n} {( {H}_{i , j} - {M}_{i} )}^{3}}{{( \frac{1}{n} {\sum }_{j = 1}^{n} {( {H}_{i , j} - {M}_{i} )}^{2} )}^{3 / 2}} .\end{matrix}$$

At 508, images with symmetric histograms are removed from being considered a matching image. The smaller the skewness Si the closer to symmetric is Hi. If Si is small (close to zero), then the histogram Hi is almost symmetric. An almost symmetric histogram has many descriptors in Q and Di that are “randomly” related, that is, the descriptors are not necessarily matching. Accordingly, these two images can be considered to be not matching and the image Di can be removed from the matching images.

At 510, images with a large mean are removed from being considered a matching image. When the mean (Mi) is large, then many of the matching keypoint pairs between Q and Di are quite distance and are likely to be mismatches. Additionally, the candidate images can be clustered based on the means M1, M2, . . . , M10 (in an example k-means are used) into two clusters; a first cluster of images with higher means and a second cluster of images with lower means. The images that belong to the first cluster with the hither means are removed from being considered matching images.

Referring back to FIG. 4, once one or more matching images from the plurality of candidate images have been identified, information corresponding to the matching image(s) can be sent from the network server 120 to the mobile internet device 102. In an example, the top threshold number (e.g., 5) of matching images can be sent to the mobile internet device 102. The matching image(s) themselves or a compressed version (e.g., a thumbnail) of the matching image(s) can be sent to the mobile internet device 102. In addition to or instead of the matching image(s) themselves, the webpage link information associated with the matching image(s) can be sent to the mobile internet device 102. In an example, the webpage link information can include a link to a Wikipedia page associated with the matching image. In other examples, other information such as text copied from the webpage associated with the matching image can be sent to the mobile internet device 102.

At 416, the mobile internet device 102 can render an object indicating that information has been received from the network server 120 on the display 212. In an example, the object can be a wiki tag related to the query image or a transparent graphic. At 418, in an example, the object can be overlaid on a live video feed from the camera 210. For example, the display 212 can display a live video feed from the camera 210 and (at 402) an image can be acquired from the live video feed as described above. Then, once information is received regarding a matching image, an object can be overlaid on the live video feed a short time after the query image was acquired. Accordingly, the live video feed can be augmented with information based on the image matching with an image extracted from the live video feed.

In an example, the object when selected by a user of the mobile internet device 102 can display a plurality of the matching images (or information related thereto) and allow the user to select a matching image that the user believes corresponds to the query image. Once one of the matching images is selected, the user can be provided with a link to the webpage or other information corresponding to the selected image.

In another example, once the information regarding the matching images is received from the network server 120, the matching images can be (e.g., automatically) displayed on the display 212. The user can then select the matching image that the user believes matches the query image. Once the user selects an image, an object can be placed on the display 212 with the information corresponding to the selected image. Then, when the object is selected by a user, the object can link the user to the webpage from which the matching image is associated. Accordingly, the user can obtain information related to the query image by selecting the object.

In an example, the object can be “pinned” to a positioning of a real life entity in the display of the live video feed and the object can track the displayed location of the real life entity as the real life entity moves within the display 212. For example, as the camera 210 or the mobile internet device 102 is moved around, the video acquired by the camera 210 changes which, in turn, causes the displayed live video feed to change. Thus, a real life entity shown in the displayed live video feed will move to the right in the display 212 as the camera 210 pans to the left. When the object is pinned to, for example, a bridge in the live video feed, the object will move with the bridge as the camera 210 or the mobile internet device 102 are moved. Thus, as the bridge moves to the right in the display 212, the object also moves to the right in the display 212. When the bridge is no longer in the field of view of the camera 210 and thus, not shown on the display 212, the object can also be not shown on the display. In other examples, when the bridge is no longer being displayed, the object can be shown on an edge of the display 212, for example, the edge nearest the hypothetically displayed location of the bridge.

Although the object has been described as having certain functionality, in other examples, the object can have other or additional functionality corresponding to the mobile augmented reality system.

At 420, in an example, the direction or orientation of the mobile interne device 102 can be tracked from the direction or orientation when the query image is acquired. This tracking can be done using the sensors on the device (e.g., the gyroscope, compass, GPS receiver). Additional detail regarding continuously tracking the movement using the sensors can be found in WikiReality: augmenting reality with community driven websites, Gray D., Kozintsev, I., International Conference on Multimedia Expo. ICME (2009) which is hereby incorporated herein by reference in its entirety.

In some examples, the tracking can also be performed based on the images acquired by the camera 210. For example, image based stabilization can be performed based on aligning neighbor frames in the input image sequence use a low parametric motion model. A motion estimation algorithm can be based on multi-resolution, iterative gradient based strategy, optionally robust in a statistical sense. Additional detail regarding the motion estimation algorithm can be found in An iterative image registration technique with application to stereo vision Lucas, B. D., Kanade, T. pgs. 674-679, and Robust multiresolution alignment of MRI brain volumes Nestares, O. Heeger, D. J., pg. 705-715, which are both incorporated by reference herein in their entirety. In an example, pure translation (2 parameters) can be used as a motion model. In another example, pure camera rotation (3 parameters) can be used as a motion model. In an example, the tracking algorithm can be optimized by using a simplified multi-resolution pyramid construction with simple 3-tap filters. The tracking algorithm can also be optimized by using a reduced linear system with gradients from only 200 pixels in the image instead of from al the pixels in the image. In another example, the tracking algorithm can be optimized by using SSE instructions for the pyramid construction and the linear system solving. In yet another example, the tracking algorithm can be optimized by using only the coarsest levels of the pyramid to estimate the alignment.

Although certain functions (e.g., identification of matching images) have been described as occurring on the network processor 120, and certain function (e.g., feature extraction from query image) have been described as occurring on the mobile internet device 102, in other examples, different functions may occur on either the network server 120 or the mobile interne device 102. Additionally, in one example, all processing described above as occurring on the network server 120 can occur on the mobile internet device 102.

In this disclosure, a complete end-to-end mobile augmented reality system is described including a mobile internet device 102 and a web-based mobile augmented reality service hosted on a network server 120. The network server 120 stores an image database 410 crawled from geotagged English Wikipedia pages, and can be updated on a regular basis. A mobile augmented reality client application can be executing on the processor 206 of the mobile internet device 102 to implement functions described above.

Embodiments may be implemented in one or a combination of hardware, firmware and software. Embodiments may also be implemented as instructions stored on a computer-readable medium, which may be read and executed by at least one processing circuitry to perform the operations described herein. A computer-readable medium may include any mechanism for storing in a form readable by a machine (e.g., a computer). For example, a computer-readable medium may include read-only memory (ROM), random-access memory (RAM), magnetic disk storage media, optical storage media, flash-memory devices, and other storage devices and media.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method for a mobile augmented reality system comprising:
acquiring a first image at a device;
obtaining information corresponding to at least one second image matched with the first image from a server; and
augmenting a displayed image on the device with the information.

2. The method of claim 1, wherein augmenting a displayed image includes overlaying an object on a live camera view.

3. The method of claim 2, wherein the object includes a link to the at least one second image;
wherein when one of the at least one second image is selected, information corresponding to the selected at least one second image is displayed.

4. The method of claim 1, comprising:
extracting features from the first image;
sending features corresponding to the first image to a server; and
wherein obtaining information includes receiving information from the server.

5. The method of claim 4, comprising:
acquiring geographical coordinates corresponding to the first image; and
sending the geographical coordinates to the server.

6. The method of claim 5, wherein the method is performed by a mobile internet device; and
wherein the mobile internet device acquires the first image with an associated camera, and acquires the geographical coordinates with an associated global positioning system (GPS) receiver, wherein the geographical coordinates correspond to the GPS coordinates of the mobile internet device when the first image is acquired.

7. A method for a mobile augmented reality system comprising:
receiving features corresponding to a first image from a device;
receiving geographical coordinate information corresponding to the first image;
identifying at least one second image that matches with the first image using the features and the geographical coordinate information; and
sending information corresponding to the at least one second image to the device.

8. The method of claim 7, comprising:
selecting a plurality of images from an image database that have corresponding geographical coordinate information within a threshold distance of the geographical coordinate information corresponding to the first image; and
wherein identifying includes comparing each of the plurality of images to first image.

9. The method of claim 7, wherein identifying includes:
identifying keypoints from images in an image database that match with keypoints from the first image; and
ranking images from the image database based on the number of matching keypoints in the image.

10. The method of claim 9, wherein identifying keypoints includes determining that a first keypoint from the first image matches a second keypoint in a third image from the image database when the second keypoint is the nearest keypoint in the third image to the first keypoint, wherein the first keypoint is matched to a single keypoint in the third image.

11. The method of claim 9, comprising:
building a histogram of minimum distances between matched keypoints of the first image and a third image in the image database;
computing a mean of the histogram;
determining that the third image is not a match to the first image when the mean is larger than a threshold.

12. The method of claim 9, comprising:
building a histogram of minimum distances between matched keypoints of the first image and a third image in the image database;
computing a skewness of the histogram; and
determining that the third image is not a match to the first image when the skewness is smaller than a threshold.

13. The method of claim 7, comprising:
populating an image database for matching with images received from the device by including images from geotagged webpages; and
associating an image from a geotagged webpage with the geographical coordinates corresponding to the geotagged webpage.

14. The method of claim 13, wherein the sending information includes sending a link to a webpage corresponding to the at least one second image.

15. The method of claim 13, comprising:
populating the image database by searching for images using a title of a geotagged webpage as a search string; and
associating one or more of the images identified using the search string with the geographical coordinates corresponding to the geotagged webpage.

16. The method of claim 15, wherein sending information includes sending a link to a geotagged webpage in which the title of the geotagged webpage was used as a search string to identify the at least one second image.

17. The method of claim 15, wherein the geotagged webpages include Wikipedia webpages.

18. A server coupled to the internet comprising at least one processor configured to:
receive features corresponding to a first image from a device;
receive geographical coordinate information corresponding to the first image;
identify at least one second image that matches with the first image using the features and the geographical coordinate information; and
send information corresponding to the at least one second image to the device.

19. The server of claim 18, wherein the at least one processor is configured to:
select a plurality of images from an image database that have corresponding geographical coordinate information within a threshold distance of the geographical coordinate information corresponding to the first image; and
identify the closest image from the plurality of images as a matching with the first image.

20. The server of claim 18, wherein the at least one processor is configured to:
populate an image database for matching with images received from the device by including images from geotagged webpages;
associate an image from a geotagged webpage with the geographical coordinates corresponding to the geotagged webpage;
populate the image database by searching for images using a title of the geotagged webpage as a search string; and
associate one or more of the images identified using the search string with the geographical coordinates corresponding to the geotagged webpage, wherein the sending information includes sending a link to a webpage corresponding to the at least one second image.
